(19) United States
(12) Patent Application Publication
(10) Pub. No.: US 2010/0311538 A1
(43) Pub. Date: Dec. 9, 2010

(54) HYDRAULIC PRESSURE SUPPLY DEVICE OF AUTOMATIC TRANSMISSION

(75) Inventors: Tomohiro MIYABE, Nagoya-shi (JP); Ryoichi HIBINO, Nagoya-shi (JP); Shinobu NAKAMURA, Nagoya-shi (JP); Masahiro TOMIDA, Toyoake-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/726,685

(22) Filed: Mar. 18, 2010

(30) Foreign Application Priority Data
Jun. 8, 2009 (JP) 2009-137458

(51) Int. Cl. F16H 61/38

(52) U.S. Cl. 477/2; 477/52

(57) ABSTRACT

A hydraulic pressure supply device of an automatic transmission which supplies working oil to the automatic transmission capable of utilizing the oil pressure to make any of a plurality of frictional engagement devices selectively engaged, thereby performing gear shift to transmit the power from an engine to driving wheels of a vehicle is disclosed. The device includes: a hydraulic pressure supply mechanism at the driving of the engine which supplies the working oil to the automatic transmission by the power from the engine; an accumulator for pressure accumulation which accumulates the pressure of the working oil; and a start-up hydraulic pressure supply control mechanism which supplies the working oil pressure-accumulated in the accumulator for pressure accumulation to a frictional engagement device for startup made to be engaged at the startup of the vehicle among a plurality of frictional engagement devices if the restart of the engine is performed after the automatic stop of the engine, wherein the start-up hydraulic pressure supply control mechanism supplies the working oil to the frictional engagement device for startup by a system separate from the hydraulic pressure supply mechanism at the driving of the engine.

### CROSS REFERENCE TO RELATED APPLICATIONS

This application is based on and claims priority under 35 U.S.C §119 to Japanese Patent Application 2009-137458, filed on Jun. 8, 2009, the entire content of which is incorporated herein by reference.

### TECHNICAL FIELD

This disclosure relates to a hydraulic pressure supply device of an automatic transmission which supplies working oil to the automatic transmission capable of utilizing oil pressure to make any of a plurality of frictional engagement devices selectively engaged, thereby performing gear shift to transmit the power from an engine to driving wheels of a vehicle.

### BACKGROUND DISCUSSION

Conventionally, in order to improve the fuel consumption performance of an engine, a technique of performing an automatic stop of the engine under a predetermined automatic stop condition and then performing the automatic restart of the engine under a predetermined restart condition when an automobile has stopped, for example, at an intersection, etc., is known. In this regard, if the automatic stop of the engine is performed, the driving of a mechanical oil pump which supplies working oil to a hydraulic pressure control device in an automatic transmission by utilizing the power of the engine also stops, and oil pressure drops in the hydraulic pressure control device to an extent that leakage of the working oil has occurred. In that state, a frictional engagement device for startup (a clutch or brake for startup) which is provided in the automatic transmission and made to be engaged at startup of a vehicle is also in a released state where the oil pressure required for engagement is not supplied thereto from the hydraulic pressure control device. Thereafter, when the automatic restart of the engine is performed to start the vehicle, if the engagement of the frictional engagement device for startup is not rapidly performed, blow-up of engine rpm occurs, or as the frictional engagement device for startup engages after the engine rpm becomes high, and the responsiveness at the startup of the vehicle degrades, due to the generation of vibration or shock, for example.

In JP-A-8-14076, when the working oil discharged from a mechanical oil pump driven by utilizing the power of an engine during the operation of the engine is pressure-accumulated in advance in an accumulator, and when the automatic stop of the engine is performed, the working oil pressure-accumulated in the accumulator is supplied to a hydraulic pressure control device in an automatic transmission. When the automatic restart of the engine is performed to start a vehicle, the oil pressure required for the engagement of a frictional engagement device for startup in the automatic transmission is secured by the working oil supplied to the hydraulic pressure control device from the accumulator.

Moreover, in JP-A-2000-313252, the oil pressure required for the engagement of a frictional engagement device at forward driving and reverse driving is secured by supplying the working oil pressure-accumulated in an accumulator to a forward or reverse clutch via a switching valve, at the restart of an engine.

When the automatic restart of the engine is performed to start the vehicle, in order to rapidly perform the engagement of the frictional engagement device for startup in the automatic transmission, it is desirable to rapidly raise the pressure of the working oil supplied to the frictional engagement device for startup.

Additionally, although the accumulator is suitable for supplying high-pressure working oil instantaneously, there is a limit to the amount of working oil to be stored. On the other hand, in an oil passage to the frictional engagement device for startup through which the oil pressure is supplied from the accumulator, the influence of the oil pressure which is lost when passing through a manual valve, etc. is nonnegligible. For this reason, there is a problem in that the amount of the working oil which should be stored in filling an oil chamber of the frictional engagement device will increase.

### SUMMARY

According to an aspect of this disclosure, there is provided a hydraulic pressure supply device of an automatic transmission which supplies working oil to the automatic transmission capable of utilizing oil pressure to make at least any one of a plurality of frictional engagement devices selectively engaged, thereby performing a gear shift to transmit the power from an engine to driving wheels of a vehicle. The device includes a hydraulic pressure supply mechanism at the driving of the engine which supplies the working oil to the automatic transmission by the power from the engine; an accumulator for pressure accumulation which accumulates the pressure of the working oil; and a start-up hydraulic pressure supply control mechanism which supplies the working oil pressure-accumulated in the accumulator for pressure accumulation to a frictional engagement device for startup made to be engaged at the startup of the vehicle among a plurality of frictional engagement devices if the restart of the engine is performed after the automatic stop of the engine. The start-up hydraulic pressure supply control mechanism supplies the working oil to the frictional engagement device for startup by a system separate from the hydraulic pressure supply mechanism at driving of the engine.

### BRIEF DESCRIPTION OF THE DRAWINGS

The foregoing and additional features and characteristics of this disclosure will become more apparent from the following detailed description with the reference to the accompanying drawings, wherein

FIG. 1 is a view showing the schematic configuration of a drive system of an automobile including an automatic transmission;

FIG. 2 is a view showing the schematic configuration of a hydraulic pressure supply device of Configuration Example 1;

FIG. 3 is a view showing the schematic configuration of a hydraulic pressure supply device of Configuration Example 2;

FIG. 4 is a view showing the schematic configuration of a hydraulic pressure supply device of Configuration Example 3;

FIG. 5 is a view showing the schematic configuration of a hydraulic pressure supply device of Configuration Example 4; and

FIG. 6 is a view showing the state of oil pressure in a frictional engagement device at startup.

### DETAILED DESCRIPTION

A mode for carrying out this disclosure (hereinafter referred to as an “embodiment”) will now be described with reference to the drawings.

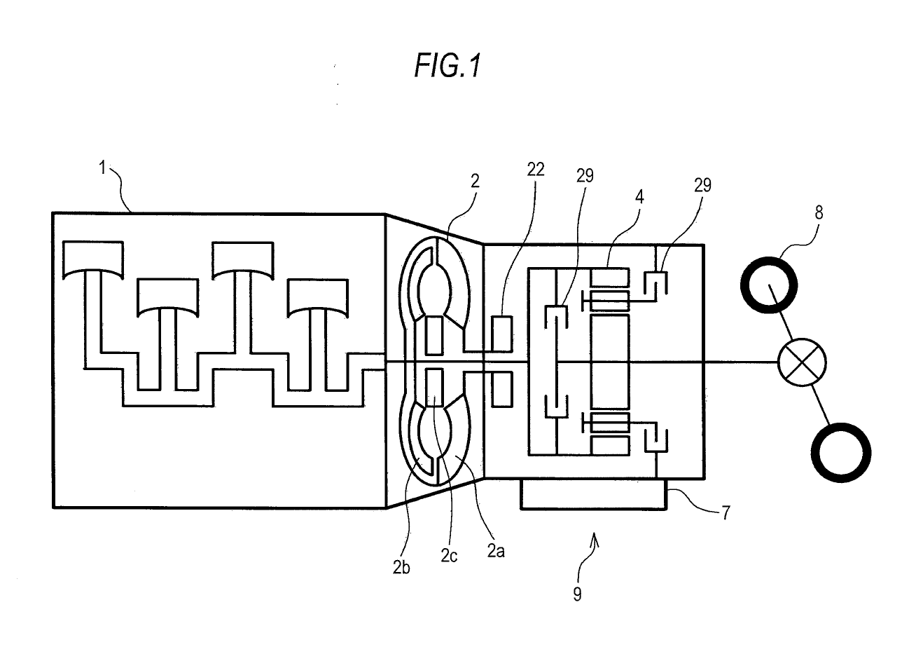

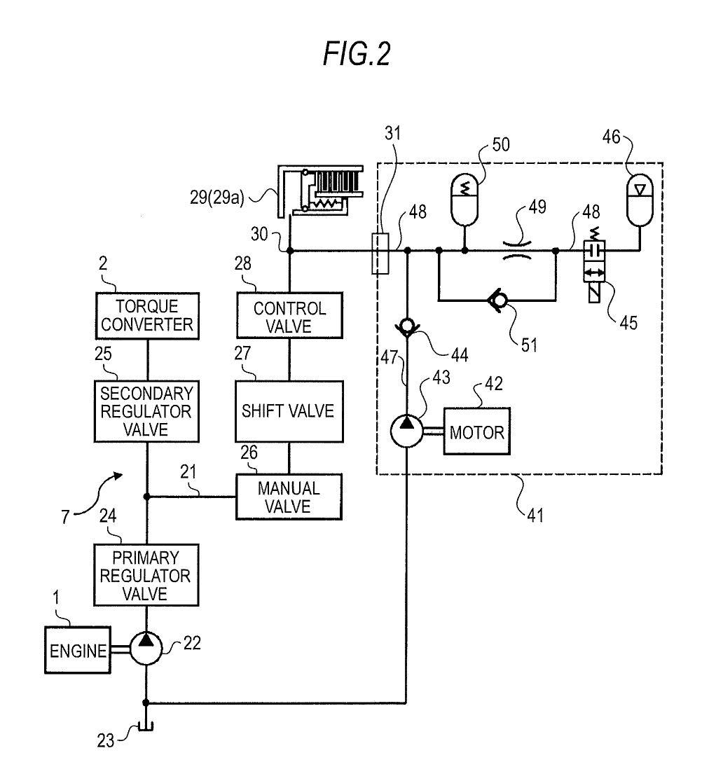

FIG. 1 is a view showing the schematic configuration of a drive system of an automobile including an automatic transmission, and FIG. 2 is a view showing the schematic configuration of a hydraulic pressure supply device of an automatic transmission according to an embodiment disclosed herein. The power generated by an engine (combustion engine) 1 is transmitted to a planetary gear mechanism 4 of an automatic transmission 9 via a torque converter 2. Here, the torque converter 2 can include a pump impeller 2a coupled with the engine 1, a turbine impeller 2b coupled with the planetary gear mechanism 4 and having torque transmitted thereto from the pump impeller 2a via a fluid (working oil), and a fixed impeller 2c supported by a housing via a one way clutch. The torque converter also has a function to transmit the torque from the engine 1 to the planetary gear mechanism 4 via the fluid, and when a rotational speed difference is generated between the pump impeller 2a and the turbine impeller 2b, has a function to amplify the torque from the engine 1 to transmit the torque to the planetary gear mechanism 4. The automatic transmission 9 performs gear shift and thus transmits the power from the engine 1 to driving wheels 8 of a vehicle. Here, the automatic transmission 9 can include the planetary gear mechanism 4 which has a plurality (two in an example shown in FIG. 1) of rotational degrees of freedom, a plurality (two in the example shown in FIG. 1) of frictional engagement devices 29 for limiting the rotational degrees of freedom of the planetary gear mechanism 4, and a hydraulic pressure control device 7 which controls the supply of hydraulic pressure to each frictional engagement device 29, thereby controlling the engagement/release of each frictional engagement device 29. Each frictional engagement device 29 can be constituted by, for example, a clutch or a brake. In the automatic transmission 9, the oil pressure in the hydraulic pressure control device 7 can be utilized to make at least any one of the plurality of frictional engagement devices 29 selectively engaged so that the planetary gear mechanism 4 assume one rotational degree of freedom, thereby performing a gear shift by the planetary gear mechanism 4 to transmit the power from the engine 1 to the driving wheels 8. Additionally, the change gear ratio of the automatic transmission 9 (planetary gear mechanism 4) can be changed in multiple stages by switching a frictional engagement device made to be engaged among the plurality of frictional engagement devices 29. In addition, the configuration of the automatic transmission 9 (the planetary gear mechanism 4 and the frictional engagement devices 29) is not limited to the configuration shown in FIG. 1, and various other configurations can also be applied.

Next, a configuration example of the hydraulic pressure control device 7 of the automatic transmission 9 will be described with reference to FIG. 2. In the example shown in FIG. 2, the hydraulic pressure control device 7 includes a primary regulator valve 24, a secondary regulator valve 25, a manual valve 26, a shift valve 27, and a control valve 28. A mechanical oil pump 22 (hydraulic pressure supply mechanism at driving of an engine) is rotationally driven utilizing the power generated by the engine 1 to pump up the working oil stored in an oil pan 23 and discharge the working oil to the primary regulator valve 24. The primary regulator valve 24 regulates the pressure of the working oil discharged from the mechanical oil pump 22 and thus supplies the working oil to an original pressure line 21, thereby setting the line pressure (the pressure of the working oil in the original pressure line 21) that is the original pressure of the hydraulic pressure control device 7. The secondary regulator valve 25 decompresses the working oil from the original pressure line 21 from line pressure, and thus supplies the working pressure to the torque converter 2. The working oil from the secondary regulator valve 25 is also used for lubrication, etc. in each lubrication system of the automatic transmission 9.

Additionally, the working oil of the original pressure line 21 is supplied to the shift valve 27 via the manual valve 26. The shift valve 27 switches oil passages between the original pressure line 21 and the plurality of frictional engagement devices 29 according to the traveling ranges and shift stages of the automatic transmission 9, thereby determining to which frictional engagement device of the plurality of frictional engagement devices 29 the working oil from the original pressure line 21 is supplied.

The manual valve 26 changes the oil passages inside the automatic transmission by the movement of the position of a valve spool in conjunction with a shift lever at a driver's seat, and selects any of the plurality of frictional engagement devices 29 to which the oil pressure is to be supplied. By changing the combination of the engagement state of the plurality of frictional engagement devices 29 depending on the position of the valve spool of the manual valve 26, a forward driving state where the power from the engine is transmitted to the driving wheels 8 in the same rotational direction as the rotational direction of the engine, a reverse driving state where the power from the engine 1 is transmitted to the driving wheels 8 in a rotational direction reverse to the rotational direction of the engine, and a neutral state where the power from the engine is not transmitted to the driving wheels 8, etc. are produced.

The control valve 28 decompresses the working oil from the shift valve 27 from line pressure, and thus supplies to the frictional engagement device 29 via a engagement pressure supply line 30. In addition, although a frictional engagement device 29a for startup made to be engaged at the startup of the vehicle among the plurality of frictional engagement devices 29 is illustrated in FIG. 2, the number of frictional engagement devices 29 to be provided depends on the number of shift stages of the automatic transmission 9. As the frictional engagement device 29a for startup, for example, a frictional engagement device made to be engaged in a case where a first speed (whose change gear ratio is the greatest) of the shift stages of the automatic transmission 9 is selected. The frictional engagement devices 29a for startup may be single or plural.

In the present embodiment, in order to improve the fuel consumption performance of the engine 1, the control of automatically stopping or automatically restarting the engine 1 according to the traveling state of the vehicle is performed by an electronic control unit. Examples of the automatic stop conditions of the engine 1 include the condition that is “a vehicle being in a stopped state”, the conditions that are “a vehicle being in a stopped state” and “accelerator-off” (a state where an accelerator pedal is not depressed) when the traveling range of the automatic transmission 9 is an N range or a P range, or the conditions that are “a vehicle being in a stopped state”, “accelerator-off”, and “brake-on” (a state where a brake pedal is depressed) when the traveling range of the automatic transmission 9 is a D range. On the other hand, an example of automatic restart conditions of the engine 1 includes a state where such automatic stop conditions are not satisfied. However, the automatic stop conditions and automatic restart conditions of the engine 1 are not limited to the examples given above, and other conditions can also be used.

If the vehicle stops, the automatic stop conditions of the engine 1 are satisfied, and thus the automatic stop of the engine 1 is performed, the rotational driving of the mechanical oil pump 22 also stops, and the working oil is no longer discharged from the mechanical oil pump 22. Since the working oil having been supplied to the torque converter 2, each frictional engagement device 29, or each lubrication system from the hydraulic pressure control device 7 gradually leaks down to the oil pan 23, the oil pressure in the hydraulic pressure control device 7 drops to the extent that the leakage of the working oil has occurred. In that state, the frictional engagement device 29a for startup is also in a released state where the oil pressure required for engagement is not supplied thereto from the hydraulic pressure control device 7. Thereafter, when the automatic restart conditions of the engine 1 are satisfied, and the automatic restart of the engine 1 is performed to start the vehicle, if the engagement of the frictional engagement device 29a for startup is not rapidly performed, blow-up of engine rpm occurs, or as the frictional engagement device 29a for startup engages after the engine rpm becomes high, vibrations or shocks are generated, and thus the responsiveness at the startup of the vehicle, degrades, which gives the driver of the vehicle discomfort and a feeling of strangeness.

Thus, in the present embodiment, in a case where the vehicle stops, and the automatic stop of the engine 1 is performed, leakage (drop in oil pressure) of the working oil in the automatic transmission 9 (the hydraulic pressure control device 7) is compensated by supplying the working oil to the automatic transmission 9 (the hydraulic pressure control device 7) from the hydraulic pressure supply device 41 (start-up hydraulic pressure supply control mechanism). Hereinafter, Configuration Example 1 of the hydraulic pressure supply device 41 will be described with reference to FIG. 2.

### Configuration Example 1

The hydraulic pressure supply device 41 includes an electric motor 42, a leak flow rate compensating oil pump 43, a check valve 44, a hydraulic pressure supply control valve 45, an accumulator 46 for pressure accumulation, an orifice 49, and a pressure regulating accumulator 50. In addition, the orifice 49 and the pressure regulating accumulator 50 function as a pressure-reducing device (pressure-reducing mechanism) of the working oil of the accumulator 46 for pressure accumulation. The external leak flow rate compensating oil pump 43 is rotationally driven utilizing the power generated by the electric motor 42 that is a power source separate from the engine 1, pumps up the working oil stored in the oil pan 23, and thus discharges the working oil to a pumping pressure supply line 47. The pumping pressure supply line 47 is connected to an engagement pressure supply line 30 which supplies the working oil to the frictional engagement device 29a for startup via the check valve 44 and a line pressure detection port 31.

The check valve 44 is provided between a discharge port of the leak flow rate compensating oil pump 43 and the pumping pressure supply line 47 to allow the working oil to flow to the pumping pressure supply line 47 from the discharge port of the leak flow rate compensating oil pump 43 and to cut off the backflow of the working oil to the discharge port of the leak flow rate compensating oil pump 43 from the pumping pressure supply line 47. By this check valve 44, the flow of the working oil to the automatic transmission 9 (the engagement pressure supply line 30) from the discharge port of the leak flow rate compensating oil pump 43 is allowed, the backflow of the working oil to the discharge port of the leak flow rate compensating oil pump 43 from the automatic transmission 9 (the engagement pressure supply line 30) is prevented. Here, the leak flow rate compensating oil pump 43 is a small oil pump of a low discharge pressure and a low flow rate which supplies the working oil to the automatic transmission 9 for compensating the flow rate of leakage of the working oil in the automatic transmission 9 to the oil pan 23, and its capacity is sufficiently small as compared to the mechanical oil pump 22. The driving of the leak flow rate compensating oil pump (the electric motor 42) is controlled by the electronic control unit. In addition, it is also possible to drive the leak flow rate compensating oil pump 43 by a power source other than the electric motor 42, such as a small engine other than the engine 1.

The accumulator 46 for pressure accumulation accumulates the energy of the working oil (accumulates pressure). The accumulated pressure supply line 48 is connected to the accumulator 46 for pressure accumulation via the hydraulic pressure supply control valve 45. This accumulated pressure supply line 48 branches into two, one of which is connected to the line pressure detection port 31 via the check valve 51 and the other of which is connected to the line pressure detection port 31 via the orifice 49 and the pressure regulating accumulator 50. In this example, the orifice 49 decompresses the working oil passing. Additionally, the pressure regulating accumulator 50 includes one small accumulator, and relaxes the pressure change of the working oil after passing through the orifice. That is, by the orifice 49 and the pressure regulating accumulator 50, the pressure change of the working oil which goes to the line pressure detection port 31 from the accumulator 46 for pressure accumulation is suppressed, and the pressure rise of the line pressure detection port 31 is delayed. Additionally, the working oil which goes to the accumulator 46 for pressure accumulation from the line pressure detection port 31 flows via the check valve 51. The line pressure detection port 31 is for detecting the oil pressure of the frictional engagement device 29a for startup and the frictional engagement device 29a for startup, and the engagement pressure supply line 30 which supplies the working oil to the frictional engagement device are connected to the line pressure detection port.

As the hydraulic pressure supply control valve 45 is opened to allow the communication between the accumulator 46 for pressure accumulation and the accumulated pressure supply line 48, the supply of the working oil to the automatic transmission 9 (the frictional engagement device 29a for startup) from the accumulator 46 for pressure accumulation is allowed. This allows the working oil pressure-accumulated in the accumulator 46 for pressure accumulation to be supplied to the frictional engagement device 29a for startup via the orifice 49, the pressure regulating accumulator 50, and the engagement pressure supply line 30. On the other head, as the hydraulic pressure supply control valve 45 is closed to cut off the communication between the accumulator 46 for pressure accumulation and the accumulated pressure supply line 48, the supply of the working oil to the frictional engagement device 29a for startup from the accumulator 46 for pressure accumulation is prevented. In addition, the driving (opening and closing) of the hydraulic pressure supply control valve 45 is controlled by the electronic control unit.

In addition, as for the connection between the hydraulic pressure supply device 41 and the automatic transmission 9 (frictional engagement device 29a for startup), the line pressure detection port 31 usually provided for the automatic transmission 9 is utilized. Here, the line pressure detection port 31 is a port to which a pressure sensor for detecting the oil pressure in confirming the operation of the automatic transmission 9 is attached. After the completion of confirmation of the operation of the automatic transmission 9, the accumulated pressure supply line 48 from the hydraulic pressure supply device 41 and the engagement pressure supply line 30 from the mechanical oil pump 22 (the control valve 28) are connected together via the line pressure detection port 31.

In the configuration example shown in FIG. 2, in the stopped state of the mechanical oil pump 22 (a state where the oil pressure of the engagement pressure supply line 30 has dropped), the hydraulic pressure supply device 41 and the hydraulic pressure control device 7 (the pumping pressure supply line 47, the accumulated pressure supply line 48, and the engagement pressure supply line 30) are connected together via the line pressure detection port 31. Therefore, the working oil discharged from the leak flow rate compensating oil pump 43 is able to be supplied to the automatic transmission 9 via the line pressure detection port 31. Additionally, as the hydraulic pressure supply control valve 45 is opened, the working oil pressure-accumulated in the accumulator 46 for pressure accumulation is supplied to the frictional engagement device 29a for startup via the line pressure detection port 31.

The pressure accumulation of the working oil in the accumulator 46 for pressure accumulation is performed while the operation of the engine 1 (when the engine 1 generates power). For example, if the pressure of the working oil in the accumulator 46 for pressure accumulation is lower than a lower limit, the electronic control unit brings the hydraulic pressure supply control valve 45 into an opened state, thereby making the accumulator 46 for pressure accumulation and the engagement pressure supply line 30 communicate with each other. This allows the working oil discharged from the mechanical oil pump 22 to be supplied to the accumulator 46 for pressure accumulation via the primary regulator valve 24, the manual valve 26, the shift valve 27, the control valve 28, the engagement pressure supply line 30, and the accumulated pressure supply line 48 (the check valve 51). In that case, the backflow of working oil to the discharge port of the leak flow rate compensating oil pump 43 from the accumulated pressure supply line 48 is prevented by the check valve 44. In this way, the accumulator 46 for pressure accumulation accumulates the pressure of the working oil supplied from the mechanical oil pump 22.

On the other hand, if the pressure accumulation of the working oil to the accumulator 46 for pressure accumulation is completed, like a case where the pressure of the working oil in the accumulator 46 for pressure accumulation is equal to or more than an upper limit, for example, the electronic control unit controls the hydraulic pressure supply control valve 45 to a closed state, and cuts off the communication between the accumulator 46 for pressure accumulation and the accumulated pressure supply line 48 (the original pressure line 21 of the hydraulic pressure control device 7). This stops the working oil discharged from the mechanical oil pump 22 from being supplied to the accumulator 46 for pressure accumulation. In addition, it is possible to detect the pressure of the working oil in the accumulator 46 for pressure accumulation using a pressure-detecting mechanism, such as a pressure sensor or a pressure switch, and the electronic control unit may control the hydraulic pressure supply control valve 45 on the basis of the detection value.

If the vehicle stops and the engine 1 is automatically stopped, the electronic control unit drives the electric motor 42 to drive the leak flow rate compensating oil pump 43. The working oil discharged from the leak flow rate compensating oil pump 43 is supplied to the frictional engagement device 29a for startup via the pumping pressure supply line 47 and line pressure detection port 31, as well as to the engagement pressure supply line 30 of the hydraulic pressure control device 7 connected to the frictional engagement device, and is supplied to the whole hydraulic pressure control device 7, such as the primary regulator valve 24, the secondary regulator valve 25, the shift valve 27, the control valve 28. At this time, the electronic control unit controls the hydraulic pressure supply control valve 45 to a closed state. Therefore, the supply of the working oil to the hydraulic pressure control device 7 from the accumulator 46 for pressure accumulation is prevented by the hydraulic pressure supply control valve 45. Here, the driving of the leak flow rate compensating oil pump 43 (the supply of the working oil to the hydraulic pressure control device 7 from the leak flow rate compensating oil pump 43) may be started after the rotation of the engine 1 (the mechanical oil pump 22) has stopped (for example, immediately after the stop), or may be started when the aforementioned automatic stop conditions of the engine 1 are satisfied.

Additionally, the leak flow rate compensating oil pump 43 supplies the working oil of a flow rate which is needed to compensate the leak flow rate of the working oil in the automatic transmission 9 and the hydraulic pressure control device 7 to the oil pan 23, to the automatic transmission 9 and the hydraulic pressure control device 7. More specifically, the capacity of the leak flow rate compensating oil pump 43 and the number of revolutions of the electric motor 42 are set so that the leak flow rate compensating oil pump 43 supplies the working oil of a flow rate equal to (or approximately equal to) the leak flow rate of the working oil in the hydraulic pressure control device 7 to the hydraulic pressure control device 7. This makes it possible to prevent a drop in the oil pressure caused by the leakage of the working oil to the oil pan 23 in the hydraulic pressure control device 7 even if the engine 1 (the mechanical oil pump 22) stops. The supply of the working oil to the hydraulic pressure control device 7 from the leak flow rate compensating oil pump 43 is preferably performed continuously while the aforementioned automatic restart conditions of the engine 1 are not satisfied (the automatic restart of the engine 1 is not performed). In addition, the leak flow rate of the working oil to the oil pan 23 in the automatic transmission 9 (hydraulic pressure control device 7) can be obtained, for example, experimentally.

If the automatic restart of the engine 1 is performed by a starter motor to start the vehicle after the automatic stop of the engine 1, the electronic control unit switches the hydraulic pressure supply control valve 45 from a closed state to an opened state. As the hydraulic pressure supply control valve 45 is opened, the working oil pressure-accumulated in the accumulator 46 for pressure accumulation is supplied to the frictional engagement device 29a for startup via the accumulated pressure supply line 48 and the line pressure detection port 31. In that case, the backflow of the working oil to the discharge port of the flow rate compensating oil pump 43 from the accumulator 46 for pressure accumulation is prevented by the check valve 44. Additionally, in that case, the electronic control unit stops the driving of the leak flow rate compensating oil pump 43 performed by the electric motor 42.

In addition, the switching of the hydraulic pressure supply control valve 45 to an opened state (the supply of the working oil to the frictional engagement device 29a for startup from the accumulator 46 for pressure accumulation) may be started, when the aforementioned automatic restart conditions of the engine 1 are satisfied, when the cranking of the engine 1 by the starter motor is performed, or after the automatic restart of the engine 1 is completed (for example, immediately after completion).

A shift stage (for example, first speed) of the automatic transmission 9 is selected when the engagement of the frictional engagement device 29a for startup is performed by the pressure of the working oil supplied to the frictional engagement device 29a for startup from the accumulator 46 for pressure accumulation. This makes it possible for the automatic transmission 9 to perform gear shift after the automatic restart of the engine 1 to transmit the power of the engine 1 to the driving wheels 8, and start the vehicle.

Here, the orifice 49 and the pressure regulating accumulator 50 are provided on a path from the accumulator 46 for pressure accumulation to the line pressure detection port 31. Accordingly, the high-pressure working oil from the accumulator 46 for pressure accumulation is not supplied to the line pressure detection port 31 with no change in pressure, but is regulated in pressure so as to vary gently, and is supplied to the line pressure detection port 31. Thereby, the effect is obtained that the engagement of the frictional engagement device 29a for startup is gently performed. Additionally, as described above, the accumulated pressure supply line 48 of the hydraulic pressure supply device 41 is connected to the frictional engagement device 29a for startup via the line pressure detection port 31 provided in advance to measure the oil pressure of the frictional engagement device 29a for startup. Therefore, the attachment/detachment of the hydraulic pressure supply device 41 which is an external device can be easily performed. Additionally, due to a simple structure in which only hydraulic equipment required at startup is arranged from the accumulator 46 for pressure accumulation to the frictional engagement device 29a for startup, the loss of oil pressure is also minimized.

Moreover, in the present embodiment, since the leakage of the working oil in the hydraulic pressure control device 7 (drop in oil pressure) is compensated by supplying the working oil to the hydraulic pressure control device 7 from the leak flow rate compensating oil pump 43 before the automatic restart of the engine 1 (while the engine 1 has stopped), the working oil pressure-accumulated in the accumulator 46 for pressure accumulation is hardly consumed for the compensation of the leakage of the working oil (increasing in oil pressure) in the hydraulic pressure control device 7, but is used for the engagement of the frictional engagement device 29a for startup. Accordingly, the pressure of the working oil supplied to the frictional engagement device 29a for startup can be rapidly increased, and the engagement of the frictional engagement device 29a for startup can be rapidly performed.

Since, after the restart of the engine 1, the mechanical oil pump 22 is rotationally driven utilizing the power of the engine 1, the supply of the working oil to the hydraulic pressure control device 7 from the mechanical oil pump 22 is performed. Additionally, the pressure accumulation of the working oil in the accumulator 46 for pressure accumulation can also be performed by the working oil discharged from the mechanical oil pump 22.

In addition, even if the aforementioned automatic stop conditions of the engine 1 are satisfied, the electronic control unit is also able to prohibit (not perform) the automatic stop of the engine 1 when the pressure of the working oil in the accumulator 46 for pressure accumulation is lower than a setting value. Here, the setting value is set as a threshold value of the pressure of the working oil that enables the engagement of the frictional engagement device 29a for startup. In this case, the hydraulic pressure supply control valve 45 is controlled to an opened state to perform the pressure accumulation of the working oil in the accumulator 46 for pressure accumulation by the working oil discharged from the mechanical oil pump 22. Then, after the pressure of the working oil in the accumulator 46 for pressure accumulation becomes higher than the setting value, the automatic stop of the engine 1 is allowed (performed).

### Configuration Example 2

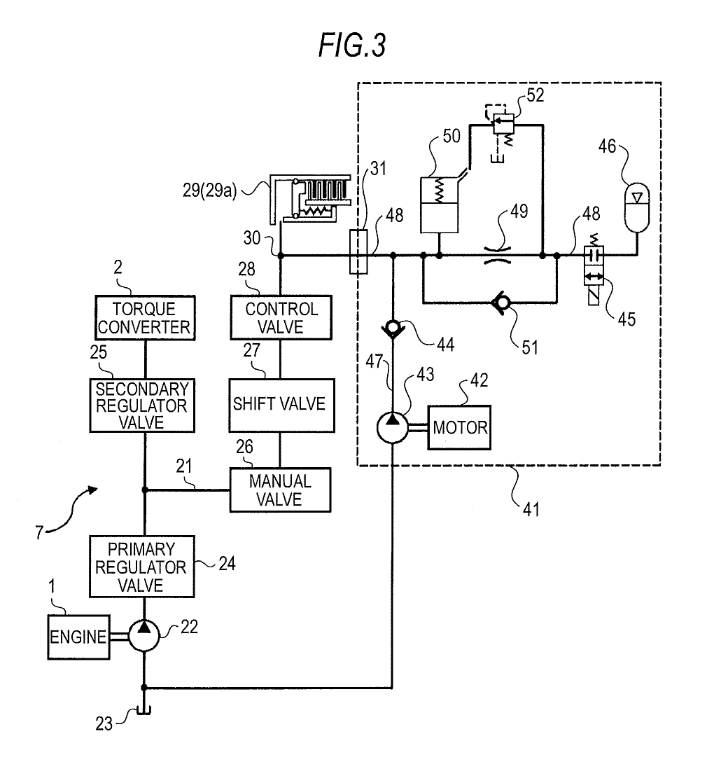

Configuration example 2 of the present embodiment is shown in FIG. 3. In this example, a hydraulic path for controlling the back pressure of the accumulator for pressure accumulation which constitutes the pressure regulating accumulator 50 serving as a pressure-reducing device, and a pressure-reducing valve 52 provided in the hydraulic path are provided in addition to the configuration of FIG. 2. The accumulated pressure supply line 48 between the hydraulic pressure supply control valve 45 and the orifice 49, and the back-pressure side of the pressure regulating accumulator 50 are connected together via the pressure-reducing valve 52.

The pressure regulating accumulator 50 houses a piston or diaphragm therein, is split into a pressure-regulating chamber and a backpressure chamber therein, and is configured such that the pressure-regulating chamber is pressurized by a mechanical spring provided in the backpressure chamber. Also, the pressure-regulating chamber of the pressure regulating accumulator 50 is connected to the accumulated pressure supply line 48 which connects the orifice 49 and the line pressure detection port 31 together.

Accordingly, in a case where the hydraulic pressure supply control valve 45 is opened to supply the oil to the accumulated pressure supply line 48 from the accumulator 46 for pressure accumulation, the pressure change of the accumulated pressure supply line 48 is eased as the oil which has passed the orifice 49 flows into the pressure-regulating chamber of the pressure regulating accumulator 50. Additionally, since the oil pressure is supplied to the backpressure chamber of the pressure regulating accumulator 50 via the pressure-reducing valve 52, the pressure of this backpressure chamber rises gradually according to the resistance of the pressure-reducing valve 52. Thus, according to the setting of the resistance in the pressure-reducing valve 52, the back pressure of the pressure regulating accumulator 50 can be arbitrarily regulated, and the engagement of the frictional engagement device 29 can be more finely controlled.

### Configuration Example 3

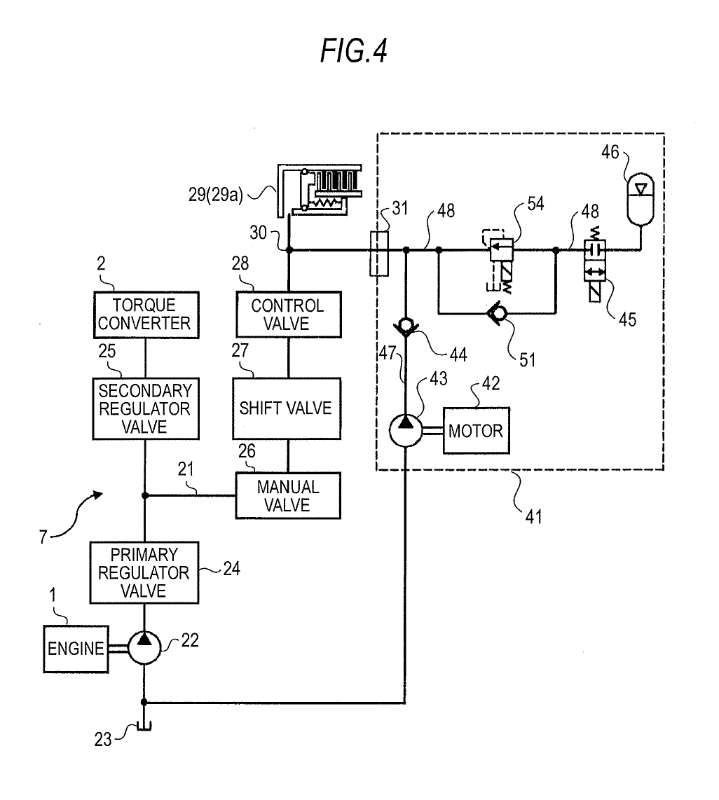

Configuration example 3 of the present embodiment is shown in FIG. 4. In this example, as a pressure-reducing device, an electromagnetic pressure-reducing valve 54 is provided instead of the orifice 49 and the pressure regulating accumulator 50 in the configuration of FIG. 2. The electromagnetic pressure-reducing valve 54 is able to be adjusted in its opening degree by an electronic control unit to regulate pressure reduction therein and arbitrarily regulate the oil pressure after passing therethrough. Thus, the oil pressure can always be controlled to an optimal value according to the engine torque or the number of revolutions at startup by controlling the oil pressure in the line pressure detection port 31 after the hydraulic pressure supply control valve 45 is opened so as to be a desired value.

### Configuration Example 4

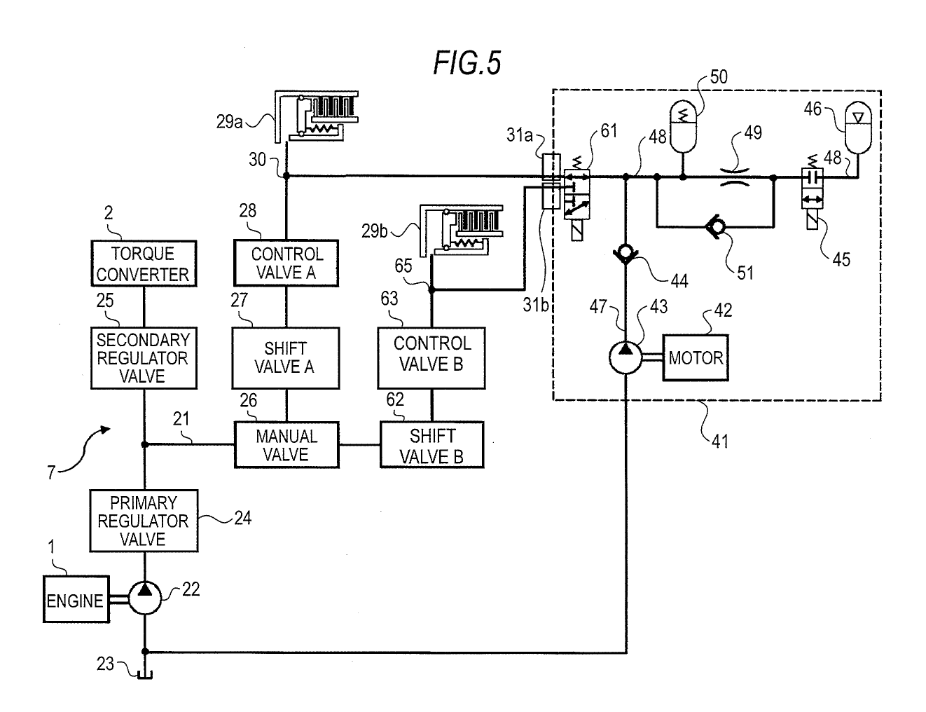

Configuration example 4 of the present embodiment is shown in FIG. 5. In this example, a directional control valve 61 for switching a frictional engagement device 29 which supplies the working oil from the accumulator 46 for pressure accumulation is provided. One side of the directional control valve 61 is connected to the frictional engagement device 29a for forward driving via a line pressure detection port 31a similarly to the above-described example, and the other side of the directional control valve 61 is connected to a frictional engagement device 29b for reverse driving via a line pressure detection port 31b.

In addition, the frictional engagement device 29b for reverse driving is connected to the manual valve 26 via a control valve 63 and a shift valve 62.

In this device, as a driver manipulates a shift lever, the valve spool of the manual valve 26 inside a hydraulic circuit of the automatic transmission moves to change oil passages, thereby switching is made among the plurality of frictional engagement devices 29 to which the oil pressure is supplied. Thus, after the engine is shutdown by idle stop, the directional control valve 61 is switched so that the working oil from the accumulator 46 for pressure accumulation is supplied to a frictional engagement device 29 selected by the manual valve 26. That is, whether the oil pressure from the accumulated pressure supply line 48 is supplied to the frictional engagement device 29a for startup or the frictional engagement device 29b for reverse driving is switched by the directional control valve 61.

In the device of the present embodiment, the hydraulic pressure control device 7 itself built in the automatic-transmission 9 is able to supply the working oil from the accumulator 46 for pressure accumulation to an arbitrary frictional engagement device 29 without any design change, by providing line pressure detection ports 31a and 31b, respectively arranged for the confirmation of the operation of the plurality of frictional engagement devices 29, and the directional control valve 61. For this reason, according to the situations, rapid startup is achieved in an arbitrary shift stage (forward, reverse, second startup, etc.). In addition, it is also preferable to change the orifice 49 and the pressure regulating accumulator 50 of FIG. 5 so as to have the configuration as shown in FIG. 2 or 4.

If the directional control valve 61 is not provided unlike the present embodiment, a plurality of orifices 49 and pressure regulating accumulators 50 for alleviating the engagement shock of the plurality of frictional engagement devices 29 used at startup must be arranged within a hydraulic circuit referred to as a valve body for the respective frictional engagement devices 29, and thus, there are problems in that not only the design of the hydraulic circuit becomes complicated, but the physical feature of the valve body becomes large, and consequently, the cost also increases. According to the present embodiment, the working oil from one accumulator 46 for pressure accumulation can be switched to be supplied to a required frictional engagement device 29.

### (Oil Pressure Change State)

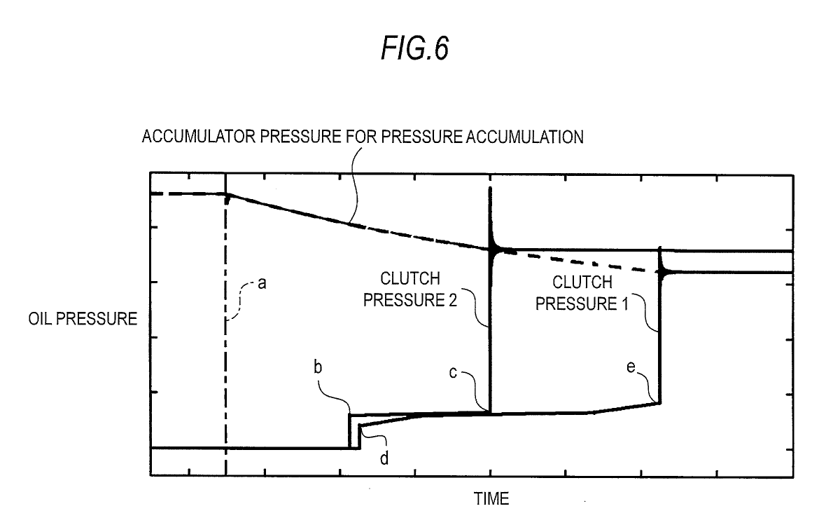

The state of the working oil at the engagement of the frictional engagement device 29a for startup according to the device of the present embodiment is shown in FIG. 6. In this drawing, clutch pressure 1 represents the oil pressure in an oil chamber of the frictional engagement device 29a when the hydraulic pressure supply control valve 45 is opened at a point of time a to supply the working oil to the frictional engagement device 29a for startup after the pressure of the working oil is accumulated in the accumulator 46 for pressure accumulation of FIG. 2. On the other hand, clutch pressure 2 represents the oil pressure in the oil chamber of the frictional engagement device when the hydraulic pressure supply control valve 45 is similarly opened at a point of time a to supply the working oil to the frictional engagement device 29a for startup, in a case where the pressure-reducing device (the orifice 49 and the pressure regulating accumulator 50) shown in FIG. 2 are omitted, and the pressure-reducing device is not incorporated into an oil passage which connects the accumulator 46 for pressure accumulation and the frictional engagement device 29a for startup together.

In the clutch pressure 2, the piston in the frictional engagement device 29a begins to push friction materials on the input side and output side at a point of time b, and the clutch pressure jumps up until it reaches the same value as the oil pressure of the accumulator 46 for pressure accumulation, at a point of time c when the gap between the friction materials is eliminated. In this way, if the oil pressure rises abruptly at a moment when the gap between the friction materials is eliminated, the time required to absorb the rotational difference between an input shaft and an output shaft cannot be sufficiently taken. For this reason, a great shock will be generated. On the other hand, in the clutch pressure 1, the oil pressure rises gently from a point of time d to a point of time e. Since the oil pressure at this point of time e shows a value higher than the oil pressure at the point of time c in the clutch pressure 2, it can be seen that the oil pressure in the oil chamber is rising gently even after the friction materials are pushed by the piston in the frictional engagement device 29a to leave no gap between them. By using the pressure-reducing device in this way, the oil pressure can be gently raised even after the gap between the friction materials is eliminated, the time for absorbing the rotational difference between an input shaft and an output shaft can be saved, and the shock at the time of engagement can be alleviated.

The hydraulic pressure supply device may be configured to further include a leak flow rate compensating hydraulic pump which is driven by a power source separate from the engine if the automatic stop of the engine is performed, thereby supplying the working oil for compensating the leak flow rate of the working oil in the automatic transmission to the automatic transmission.

The start-up hydraulic pressure supply control mechanism may have a pressure-reducing mechanism which reduces the pressure of the working oil, in a path along which the working oil is supplied to the frictional engagement device for startup from the accumulator for pressure accumulation.

The pressure-reducing mechanism may be an orifice or an accumulator for pressure reduction which is arranged in the path of the working oil.

The pressure-reducing mechanism may be an orifice and an accumulator for pressure reduction which are arranged in the path of the working oil.

The pressure-reducing mechanism may be a mechanism which regulates the back pressure of the accumulator for pressure reduction according to the pressure of the orifice or the accumulator for pressure reduction on the side of the accumulator for pressure accumulation.

The pressure-reducing mechanism may be an electromagnetic pressure-reducing valve which is arranged in the path of the working oil.

A direction switching valve may be provided in a path of the working oil from the pressure-reducing mechanism to the frictional engagement device for startup so that the working oil can be supplied to other frictional engagement devices.

According to this disclosure, since the hydraulic pressure supply control mechanism for startup supplies the oil pressure pressure-accumulated by a system separate from the hydraulic pressure supply mechanism at the driving of an engine to the frictional engagement device for startup, the oil pressure can be supplied to the frictional engagement device for startup without unnecessary resistance.

The principles, preferred embodiment and mode of operation of the present invention have been described in the foregoing specification. However, the invention which is intended to be protected is not to be construed as limited to the particular embodiment disclosed. Further, the embodiments described herein are to be regarded as illustrative rather than restrictive. Variations and changes may be made by others and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A hydraulic pressure supply device of an automatic transmission which supplies working oil to the automatic transmission capable of utilizing the oil pressure to make any of a plurality of frictional engagement devices selectively engaged, thereby performing gear shift to transmit the power from an engine to driving wheels of a vehicle, the device comprising:
a hydraulic pressure supply mechanism at the driving of the engine which supplies the working oil to the automatic transmission by the power from the engine;
an accumulator for pressure accumulation which accumulates the pressure of the working oil; and
a start-up hydraulic pressure supply control mechanism which supplies the working oil pressure-accumulated in the accumulator for pressure accumulation to a frictional engagement device for startup made to be engaged at the startup of the vehicle among a plurality of frictional engagement devices if the restart of the engine is performed after the automatic stop of the engine,
wherein the start-up hydraulic pressure supply control mechanism supplies the working oil to the frictional engagement device for startup by a system separate from the hydraulic pressure supply mechanism at the driving of the engine.

2. The hydraulic pressure supply device of an automatic transmission according to claim 1, further comprising a leak flow rate compensating hydraulic pump which is driven by a power source separate from the engine if the automatic stop of the engine is performed, thereby supplying the working oil for compensating the leak flow rate of the working oil in the automatic transmission to the automatic transmission.

3. The hydraulic pressure supply device of an automatic transmission according to claim 1,
wherein the start-up hydraulic pressure supply control mechanism has a pressure-reducing mechanism which reduces the pressure of the working oil, in a path along which the working oil is supplied to the frictional engagement device for startup from the accumulator for pressure accumulation.

4. The hydraulic pressure supply device of an automatic transmission according to claim 3,
wherein the pressure-reducing mechanism is an orifice or an accumulator for pressure reduction which is arranged in the path of the working oil.

5. The hydraulic pressure supply device of an automatic transmission according to claim 3,
wherein the pressure-reducing mechanism is an orifice and an accumulator for pressure reduction which are arranged in the path of the working oil.

6. The hydraulic pressure supply device of an automatic transmission according to claim 5,
wherein the pressure-reducing mechanism is a mechanism which regulates the back pressure of the accumulator for pressure reduction according to the pressure of the orifice or the pressure of the accumulator for pressure reduction on the side of the accumulator for pressure accumulation.

7. The hydraulic pressure supply device of an automatic transmission according to claim 3,
wherein the pressure-reducing mechanism is an electromagnetic pressure-reducing valve which is arranged in the path of the working oil.

8. The hydraulic pressure supply device of an automatic transmission according to claim 3,
wherein a direction switching valve is provided in a path of the working oil from the pressure-reducing mechanism to the frictional engagement device for startup so that the working oil can be supplied to other frictional engagement devices.
